(19) United States
(12) Patent Application Publication
(10) Pub. No.: US 2020/0355003 A1
(43) Pub. Date: Nov. 12, 2020

(54) MECHANICAL RELEASE APPARATUS AND METHOD

(71) Applicant: Bret Michael Berry, Tallahassee, FL (US)

(72) Inventor: Bret Michael Berry, Tallahassee, FL (US)

(21) Appl. No.: 16/404,307

(22) Filed: May 6, 2019

(51) Int. Cl. E05F 1/00

(52) U.S. Cl. CPC E05F 1/006; E05Y 2800/252

(57) ABSTRACT

A latch mechanism is disclosed. The latch mechanism has a first member, and a second member that is rotatable relative to the first member, the second member being rotatable in a first direction between a first position and a second position. The second member contacts the first member and is received by the first member when the second member is in the second position. The first member includes a shape memory alloy portion. The shape memory alloy portion is movable between a first shape when in a first state and a second shape when in a second state. The shape memory alloy portion moves from the first shape to the second shape based on a temperature of the shape memory alloy portion exceeding a threshold transition temperature of the shape memory alloy portion.

### TECHNICAL FIELD

The present disclosure generally relates to a release apparatus and method, and more particularly to a mechanical release apparatus and method.

### BACKGROUND

Each year, many residential and commercial buildings are destroyed by fire. These fires include brush fires or forest fires in residential areas and industrial fires in factories and plants. Unfortunately, these fires may take lives when people or animals are trapped inside the structures. Whereas adults may be generally able to escape from buildings, smaller children may not be able to open doors or windows that are latched shut. Also, animals typically have no way of opening latches. Many animals, such as pets, are kenneled inside homes and may be unable to escape during a fire. Animals such as livestock that are kept in stalls or other enclosures inside of barns or stables may similarly be unable to escape.

Conventional latches remain closed during fires. Conventional latches may also become either more difficult to open in emergencies such as fires or may experience melting or other damage due to the fire that may render the latches inoperable and/or unable to be unlocked. Accordingly, conventional latches may trap human or animal occupants within buildings during fires.

The exemplary disclosed apparatus and method are directed to overcoming one or more of the shortcomings set forth above and/or other deficiencies in existing technology.

### SUMMARY OF THE DISCLOSURE

In one exemplary aspect, the present disclosure is directed to a latch mechanism. The latch mechanism includes a first member, and a second member that is rotatable relative to the first member, the second member being rotatable in a first direction between a first position and a second position. The second member contacts the first member and is received by the first member when the second member is in the second position. The first member includes a shape memory alloy portion. The shape memory alloy portion is movable between a first shape when in a first state and a second shape when in a second state. The shape memory alloy portion moves from the first shape to the second shape based on a temperature of the shape memory alloy portion exceeding a threshold transition temperature of the shape memory alloy portion. The shape memory alloy portion moves in a second direction, which is different from the first direction, when moving from the first shape to the second shape.

In another aspect, the present disclosure is directed to a method. The method includes providing a first member attached to a first assembly, providing a second member attached to a second assembly, moving the second assembly relative to the first assembly between an open position and a closed position, and receiving one of the first and second members with the other of the first and second members when the second assembly is in the closed position to lock the second assembly to the first assembly. At least one of the first member and the second member includes a shape memory alloy portion. The shape memory alloy portion is movable between a first shape at a first ambient temperature and a second shape at a second ambient temperature that is greater than the first ambient temperature. The method also includes unlocking the second assembly from the first assembly by moving the shape memory alloy portion from the first shape to the second shape.

### BRIEF DESCRIPTION OF THE DRAWINGS

FIG. 1 is a view of a first exemplary embodiment of the present disclosure depicting a latch mechanism in an open position with an exemplary SMA component in a martensite state;

FIG. 2 is a view of a first exemplary embodiment of the present disclosure depicting a latch mechanism in a locked position with the exemplary SMA component in the martensite state;

FIG. 3 is a view of a first exemplary embodiment of the present disclosure depicting a latch mechanism in a locked position, and with the exemplary SMA component in an austenite state, thereby releasing the latch and unlocking it;

FIG. 4 is a view of a second exemplary embodiment of the present disclosure depicting an exemplary animal crate that includes a latching mechanism with an exemplary SMA component in a martensite state;

FIG. 5 is a detailed view of the exemplary latch mechanism of FIG. 4, depicting said latch mechanism in an unlocked position with the exemplary SMA component in the martensite state;

FIG. 6 is a detailed view of the exemplary latch mechanism of FIG. 4, depicting said latch mechanism in a locked position with the exemplary SMA component in the martensite state;

FIG. 7 is a detailed view of the exemplary latch mechanism of FIG. 4, depicting said latch mechanism in a locked position, and with the exemplary SMA component in an austenite state, thereby releasing the latch and unlocking it;

FIG. 8 is a detailed view of a third exemplary embodiment of an exemplary latch mechanism, with the exemplary latch mechanism in a locked position and with an exemplary SMA component in an austenite state, thereby releasing the latch and unlocking it;

FIG. 9 is a detailed view of a fourth exemplary embodiment of an exemplary catch mechanism, with the exemplary catch in a martensite state;

FIG. 10 is a view of the fourth exemplary embodiment of the exemplary catch mechanism, with the exemplary catch in the martensite state;

FIG. 11 is a detailed view of the fourth exemplary embodiment of the exemplary catch mechanism, with the catch in an austenite state;

FIG. 12 is a view of the fourth exemplary embodiment of the exemplary catch mechanism, with the catch in the austenite state;

FIG. 13 is a view of a fifth exemplary embodiment of an exemplary window latch mechanism in an open position, depicting an exemplary SMA component in a martensite state;

FIG. 14 is a view of the fifth exemplary embodiment of the exemplary window latch mechanism in a locked position, depicting the exemplary SMA component in the martensite state;

FIG. 15 is a view of the fifth exemplary embodiment of the exemplary window latch mechanism in the locked position, depicting the exemplary SMA component in an austenite state, thereby releasing the latch and unlocking it;

FIG. 16 is a view of a sixth exemplary embodiment of an exemplary window latch mechanism in an open position, depicting the exemplary SMA component in a martensite state;

FIG. 17 is a view of the sixth exemplary embodiment of the exemplary window latch mechanism in a locked position, depicting the exemplary SMA component in the martensite state; and

FIG. 18 is a view of the sixth exemplary embodiment of the exemplary window latch mechanism in the locked position, depicting the exemplary SMA component in an austenite state, thereby releasing the latch and unlocking it.

### DETAILED DESCRIPTION AND INDUSTRIAL APPLICABILITY

In at least some exemplary embodiments, the exemplary disclosed mechanism may include a mechanical latch release mechanism. The exemplary mechanical release mechanism may include two structural members disposed in a movable (e.g., slidable) relation to each other. The exemplary disclosed mechanism may include a latch that holds a first structural member in a latched position relative to a second structural member. A shape memory alloy portion (e.g., member) may be disposed within or in at least one of the first and second structural members and may be used to release the latch in predetermined circumstances (e.g., in a fire or other unsafe temperatures or conditions).

In at least some exemplary embodiments, the exemplary disclosed mechanism may include a latch mechanism (e.g., latch release mechanism) that may be automatically released based on the use and operation of shape memory alloy members (e.g., in circumstances of a fire). The exemplary latch release mechanism may be automatically activated in the case of elevated temperatures.

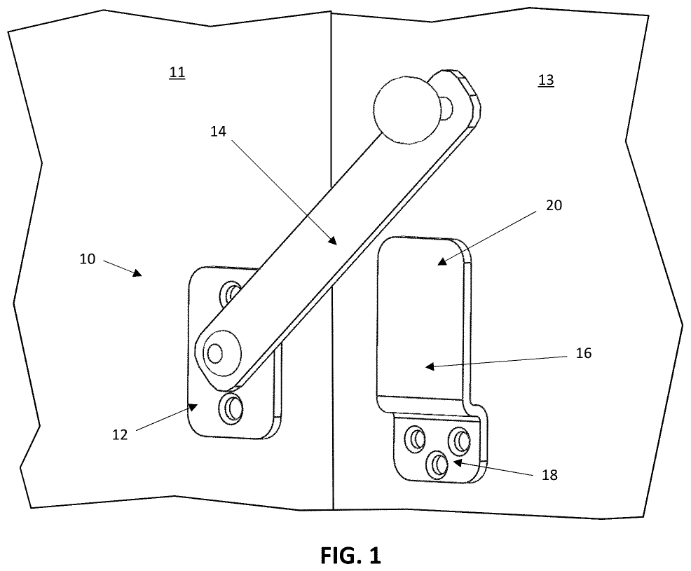

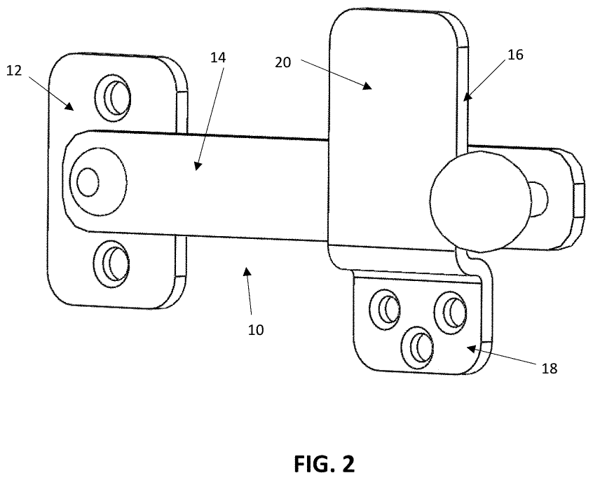

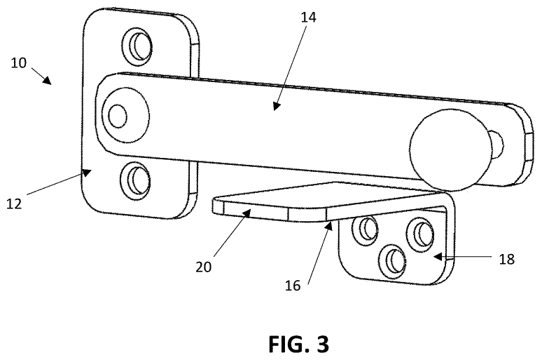

FIGS. 1-3 illustrate a first exemplary embodiment of the exemplary disclosed apparatus. As illustrated in FIGS. 1-3, the exemplary disclosed apparatus may include a mechanism 10 (e.g., any suitable locking device such as a rotating latch mechanism 10). Mechanism 10 may be installed on any suitable door such as a building (e.g., house) door, a barn door, or a stall door. Mechanism 10 may include a handle plate 12, which may be attached to an assembly such as a door 11 (e.g., or a window or similar assembly that may be opened and closed to provide access). A latch handle 14 may be attached (e.g., rotatably or pivotably attached) to handle plate 12, and may be allowed to rotate freely. A catch component 16 may be attached to an assembly (e.g., structural assembly) such as a wall 13 adjacent to door 11 and in which door 11 may be mounted. Door 11 and wall 13 are not shown in FIGS. 2 and 3 for the sake of clarity. Portions of catch component 16 may be made from any suitable state-changing material such as described for example herein.

In at least some exemplary embodiments, portions of catch component 16 may be formed from shape-memory alloy (SMA). Also for example, portions of catch component 16 may be formed from any suitable material that may change from a first state to a second state based on a change of temperature of the material (e.g., or any other suitable criteria). For example, portions of catch component 16 may change from a first state (e.g., martensite) at a first temperature of the SMA material to a second state (e.g., austenite) at a second temperature of the SMA material that is greater than the first temperature. Portions of catch component 16 may change from the second state (e.g., austenite) to the first state (e.g., martensite) upon cooling. For example, when dropping below a predetermined temperature (e.g., a transition temperature) of the SMA material, portions of catch component 16 including SMA may enter the martensite state during cooling. During heating above the predetermined temperature of the SMA material (e.g., a transition temperature), the portions of catch component 16 including SMA may transform from the first state (e.g., martensite) to the second state (e.g., austenite). Portions of catch component 16 may be formed from any suitable material that may be bent or stretched into a desired configuration in a first state (e.g., cold state such as martensite such as illustrated in FIGS. 1 and 2) and may hold that shape until heated above a predetermined temperature (e.g., transition temperature) of the SMA material. Upon heating, the portions of catch component 16 may change to an original shape in a second state (e.g., hot state such as austenite as illustrated in FIG. 3). When the portions of catch component 16 cool again to a temperature of the SMA material below the transition temperature to the first state (e.g., cool state such as martensite), the portions of catch component 16 may remain in the hot shape (e.g., as illustrated in FIG. 3), until deformed again (e.g., bent or stretched into a desired shape while in the first state that may be martensite as described above). The predetermined temperature (e.g., transition temperature) of the SMA material may be any desired temperature or temperature range such as, for example, between about 120° F. (degrees Fahrenheit) and about 200° F. or higher, between about 110° F. and about 150° F., or a temperature of the SMA material corresponding to an ambient temperature of about 120° F.

In at least some exemplary embodiments, portions of catch component 16 including SMA may exist in a first state (e.g., martensite state) at typical ambient room temperatures. For example, at ambient temperatures below 120° F. (120 degrees Fahrenheit), the portions of catch component 16 including SMA may be in its first state (e.g., martensite state). For example, the portions of catch component 16 including SMA may be in its first state (e.g., martensite state) at ambient temperatures of between about −40° F. (e.g. or less) and about 120° F., between about 32° F. and about 120° F., or between about room temperature (e.g., about 70° F.) and about 120° F. However, once a temperature rises due to a fire, the portions of catch component 16 including SMA may begin to change phase to its second state (e.g., austenite state). For example, as the ambient temperature rises above 120° F. (120 degrees Fahrenheit), portions of catch component 16 including SMA may change from the first state (e.g., martensite state) to the second state (e.g., austenite state). For example, portions of catch component 16 including SMA may change from the first state (e.g., martensite state) to the second state (e.g., austenite state) at any suitable temperature (e.g., or temperature range) that may be lower than what would cause harm to a human or animal but higher than usual or comfortable ambient temperatures (e.g., temperature associated with a fire in its incipient stages).

In at least some exemplary embodiments, portions of catch component 16 may be formed any suitable shape-memory alloy (SMA) material. For example, portions of catch component 16 may include SMA material including titanium and nickel (TiNi). Also for example, portions of catch component 16 may include SMA material including copper, aluminum, and nickel (CuAlNi) and/or titanium, nickel and palladium (TiNiPd). For example, portions of catch component 16 may include SMA material including alloying iron, zinc, gold, and copper. For example, portions of catch component 16 may include any suitable copper-based and/or iron-based SMAs. In at least some exemplary embodiments, portions of catch component 16 may include SMA materials such as Cu—Zn—Al, Fe—Mn—Si, and/or Cu—Al—Ni.

Catch component 16 may include a base 18 that mates to wall 13, and a receiving portion 20 that may be bent away from wall 13 (e.g., but may be generally parallel to wall 13 while in its first state such as the martensite state). Receiving portion 20 may receive latch handle 14 while in the first state (e.g., martensite state), as shown in FIG. 2. Also as illustrated in FIG. 2, mechanism 10 may then be locked, with latch handle 14 being held by receiving portion 20 (e.g., configured as a vertical receiving portion) of catch component 16 when receiving portion 20 is in the first state (e.g., martensite state).

FIG. 3 illustrates portions of catch component 16 including SMA in the second state (e.g., austenite state). When a temperature of the SMA material increases above the predetermined temperature (e.g., transition temperature of the SMA material corresponding to an ambient temperature such as 120° F.), receiving portion 20 that was previously in a vertical configuration moves (e.g., bends back) to its austenite state, in which receiving portion 20 may be horizontal (e.g., perpendicular to wall 13). As illustrated in FIG. 3, even though latch handle 14 may be in its locked position, mechanism 10 is in effect unlocked and a door, window, or other member (e.g., door 11) may be freely moved and opened. For example, an animal located inside a stall or barn door secured by mechanism 10 may be able to push door 11 open, thereby freeing itself and allowing it to safely exit a burning structure.

Components of the exemplary disclosed apparatus may be formed from any suitable material for providing portions of a mechanism such as a locking mechanism. For example, components of the exemplary disclosed apparatus may be formed from polymer material, structural metal (e.g., structural steel), co-polymer material, thermoplastic and thermosetting polymers, resin-containing material, polyethylene, polystyrene, polypropylene, epoxy resins, phenolic resins, Acrylanitrile Butadiene Styrene (ABS), Polycarbonate (PC), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), and/or Engineered Thermoplastic Polyurethane (ETPU), or any suitable combination thereof.

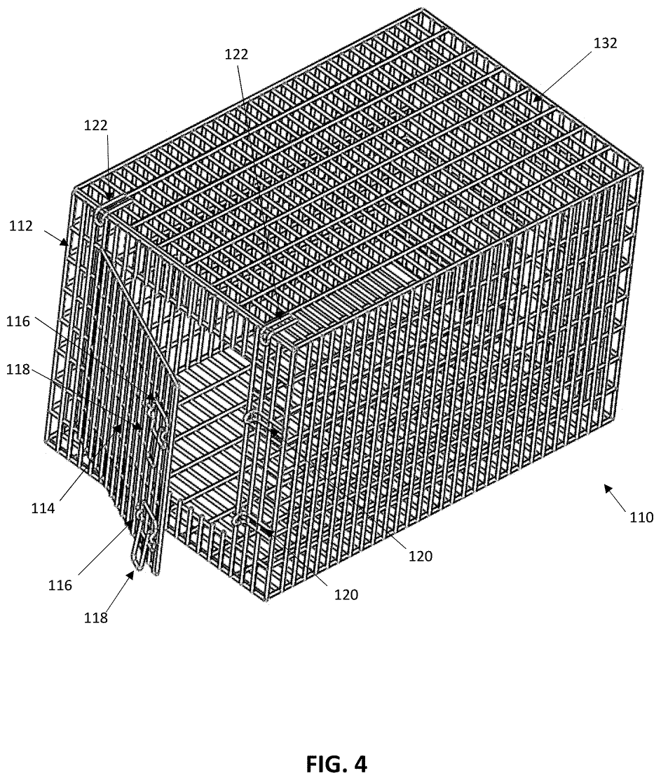

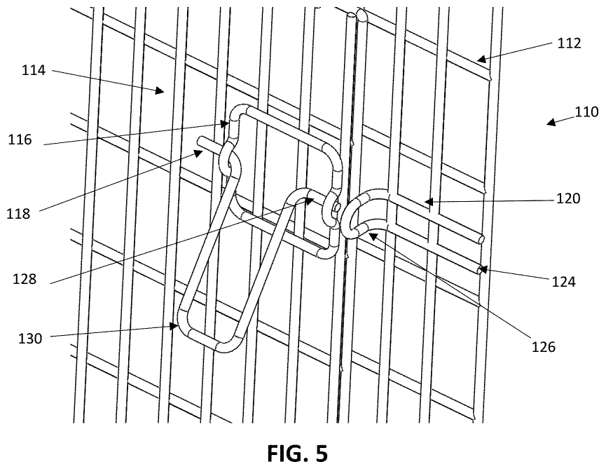

FIGS. 4-7 illustrate a second exemplary embodiment of the exemplary disclosed apparatus. The exemplary disclosed apparatus may include a structure such as a crate 110 (e.g., a wire mesh animal crate). Crate 110 may include an enclosure 132 having a front wall 112. Front wall 112 may be able to detach from enclosure 132 and swing outward, while being attached to a base of enclosure 132. Front wall 112 may be held to enclosure 132 by at least one retaining catch 122 (e.g., a plurality of retaining catches 122). Crate 110 may include a member such as a door 114 that may be attached to front wall 112. Door 114 may be able to swing outward from front wall 112. At least one latch mechanism (e.g., a plurality of latch mechanisms such as two latch mechanisms) that may be disposed on door 114 may hold door 114 shut to front wall 112. The exemplary disclosed latch mechanism may also be attached to front wall 112. The exemplary disclosed latch mechanism may include a base 116 that may retain a member such as a slidable handle 118. As illustrated in FIGS. 5-7, slidable handle 118 may include components such as a portion 128 (e.g., peg portion 128) and a handle 130 (e.g., u-shaped handle 130). Peg portion 128 may extend through base 116. For example, base 116 may hold handle 118 to door 114. U-shaped handle 130 may prevent handle 118 from falling out of base 116.

The exemplary disclosed latch mechanism may also include one or more catch components 120 that may be attached to front wall 112. Catch component 120 may be similar to catch component 116 and may for example include SMA material. As illustrated in FIGS. 5-7, catch component 120 may include a base 124 that may be attached (e.g., permanently affixed) to front wall 112. Additionally, catch component 120 may have a loop 126 (e.g., a receiving loop) that in its first state (e.g., a martensite state) may be perpendicular to front wall 112. For example, portions of catch component 120 may include SMA material that may be in the martensite state at typical ambient room temperatures. For example, at temperatures below the exemplary transition temperature described above (e.g., temperature of the SMA material corresponding to an ambient temperature of 120 degrees Fahrenheit), the portions of catch component 120 including SMA material may be in its first state (e.g., martensite state).

FIG. 5 illustrates a detailed view the exemplary disclosed latch mechanism of crate 110. Slidable handle 118 may be in an open position, with peg portion 128 being slid back within a frame of base 116. In this exemplary position, catch component 120 may be in its first state (e.g., martensite state) and door 114 may be able to open and close freely.

FIG. 6 also illustrates a detailed view of the exemplary disclosed latch mechanism of crate 110. As illustrated in FIG. 6, the exemplary latch mechanism may be in its locked position, with handle 118 being slid forward within base 116. Peg portion 128 may extend through base 116 and into receiving loop 126 of catch component 120. With peg portion 128 engaged in loop 126 while in its first state (e.g., martensite state), door 114 may be fixed to front wall 112, and thereby locked closed.

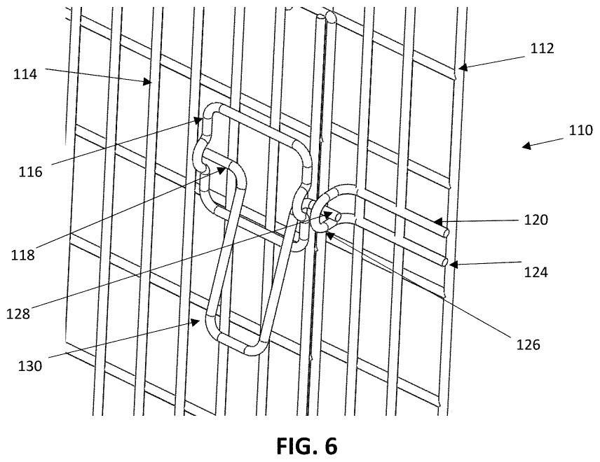

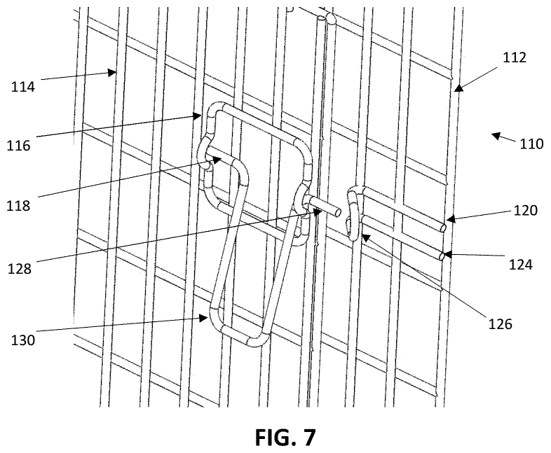

FIG. 7 also illustrates a detailed view of the exemplary disclosed latch mechanism of crate 110. As illustrated in FIG. 7, catch component 120 may be in its second state (e.g., austenite state). Receiving loop 126 of catch component 120 may be folded back on itself so that it is no longer perpendicular to front wall 112. For example, receiving loop 126 may be at an acute angle as illustrated in FIG. 7. Catch base 124 may remain attached (e.g., affixed) to front wall 112 when loop 126 has moved to the configuration illustrated in FIG. 7. Though handle 118 may be slid forward within base 116, peg portion 128 may be no longer engaged within loop 126. Accordingly as illustrated in FIG. 7, door 114 may now be unlocked and able to swing away from front wall 112. For example as illustrated in the configuration of FIG. 7, an animal may be released (e.g., an animal may push on door 114 to be released).

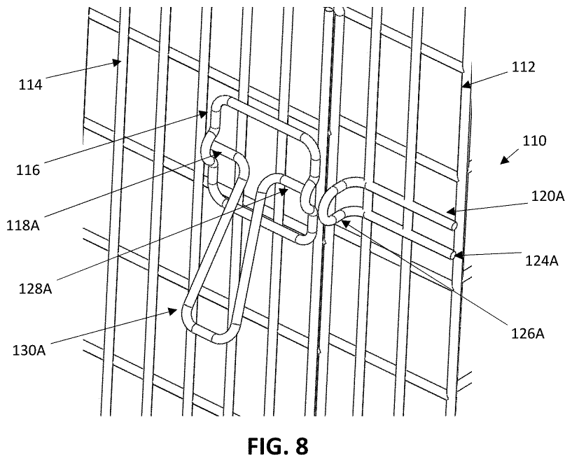

FIG. 8 illustrates a third exemplary embodiment of the exemplary disclosed latch mechanism of crate 110. The exemplary disclosed latch mechanism may include a handle 118A, a catch component 120A, a base 124A, a receiving loop 126A, a peg portion 128A, and a u-shaped handle 130A that may be generally similar to handle 118, catch component 120, base 124, receiving loop 126, peg portion 128, and u-shaped handle 130, respectively. Portions of slidable handle 118A may be formed from SMA material similar to catch component 120. Catch component 120A may not for example include SMA material. In its first state (e.g., martensite state), slide handle 118A may be configured similarly to (e.g., have an identical shape as) handle 118 depicted in FIGS. 4-6. Catch component 120A may be configured similarly to (e.g., have an identical shape as) catch component 120 depicted in FIGS. 4-6. When handle 118A changes phase to its second state (e.g., austenite state) as illustrated in FIG. 8, u-shaped handle 130A may pinch in on itself (e.g., when a temperature of the SMA material exceeds a transition temperature as described for example above). As illustrated in FIG. 8, peg portions 128A of handle 118A may retract within base 116. Peg portions 128A may therefore no longer protrude through loop 126A of catch component 120A. Door 114 may thereby be unlocked from front wall 112.

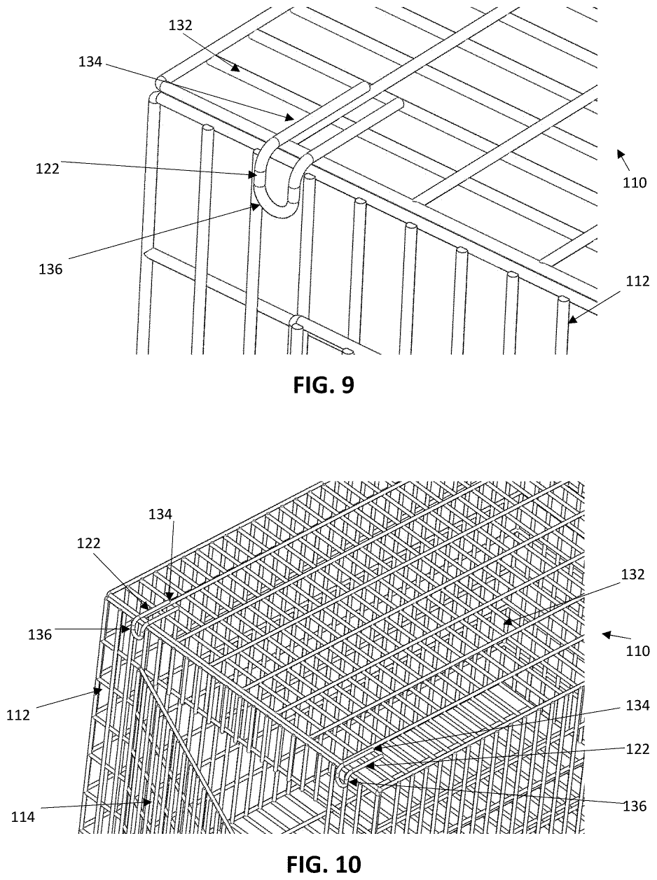

FIGS. 9-12 illustrate a fourth exemplary embodiment of the exemplary disclosed latch mechanism of crate 110. As illustrated in FIGS. 9-12, retaining catches 122, which may include SMA material, may hold front wall 112 to enclosure 132. Retaining catch 122 may include a base 134 that may be attached (e.g., permanently affixed) to enclosure 132. Retaining catch 122 may also include a retaining loop 136 that extends beyond (e.g., past) an edge of enclosure 132. In its first state (e.g., martensite state) as illustrated in FIGS. 9-10, retaining loop 136 may be bent so as to be parallel with front wall 112. Retaining loop 136 may include SMA material that may be in a first state (e.g., martensite state) at typical ambient room temperatures. For example, at ambient temperatures below 120° F. (120 degrees Fahrenheit), the SMA material may be in its first state (e.g., martensite state).

In at least some exemplary embodiments, enclosure 132 may be formed from wire mesh having suitable flexibility so that the wire mesh is able to flex. The wire mesh may be able to flex enough so that the top of the wire mesh, which may be attached to retaining catch 122, may be forcibly pulled up to allow front wall 112 to be moved under (e.g., to go under) retaining catch 122. The wire mesh of enclosure 132 may then be released (e.g., by a user), allowing retaining catches 122 that may be in their first state (e.g., martensite state) to hold front wall 112 securely against enclosure 132 as illustrated in FIG. 9.

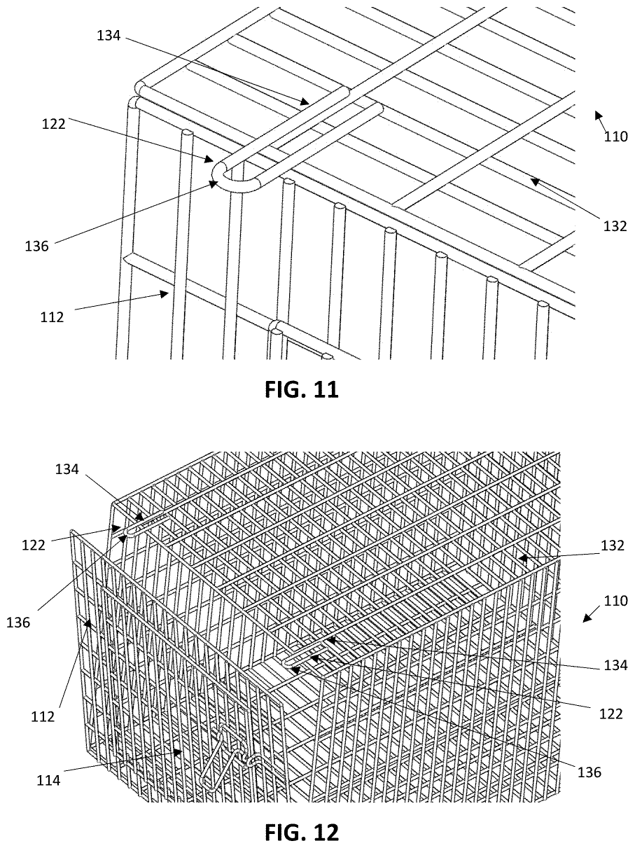

When an ambient temperature at enclosure 132 rises (e.g., due to a fire), SMA portions of retaining catch 122 may change phase back to its second state (e.g., austenite state) when a rise in the ambient temperature (e.g. as the ambient temperature rises above 120 degrees Fahrenheit) causes an internal temperature of the SMA material to rise above the exemplary transition temperature described above. The exemplary ambient temperature corresponding to the exemplary transition temperature of the SMA material may be any suitable temperature (e.g., or temperature range) that may be lower than what would cause harm to a human or animal but higher than usual or comfortable ambient temperatures (e.g., temperature associated with a fire in its incipient stages). FIGS. 11-12 depict retaining catch 122 that may include SMA material in its second (e.g., austenite state). In its second state (e.g., austenite state), retaining loop 136 of retaining catch 122 may move (e.g., flatten or straighten out) to be in line with base 134, which may remain attached to enclosure 132. Retaining catch 122 may thereby no longer hold front wall 112, and front wall 112 may be allowed to fall away from enclosure 132, thereby releasing an animal. Front wall 112 may fall away from enclosure 132 independently of whether or not door 114 is locked to front wall 112. For example, front wall 112 may fall away from enclosure 132 and door 114 may also become unlocked and open from front wall 112 simultaneously.

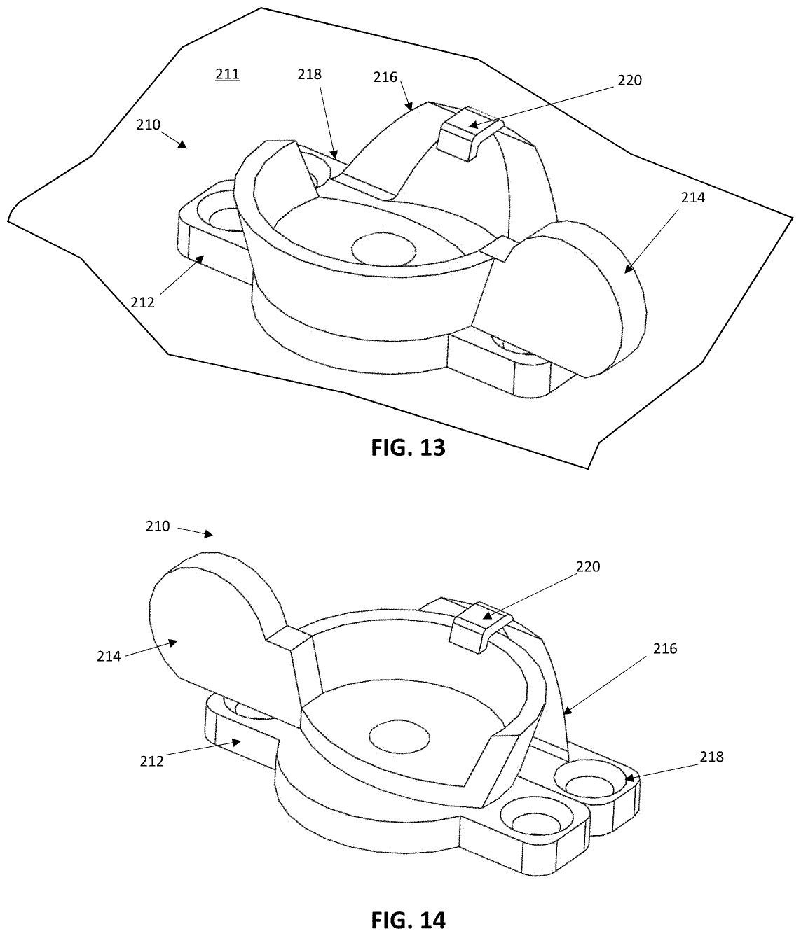

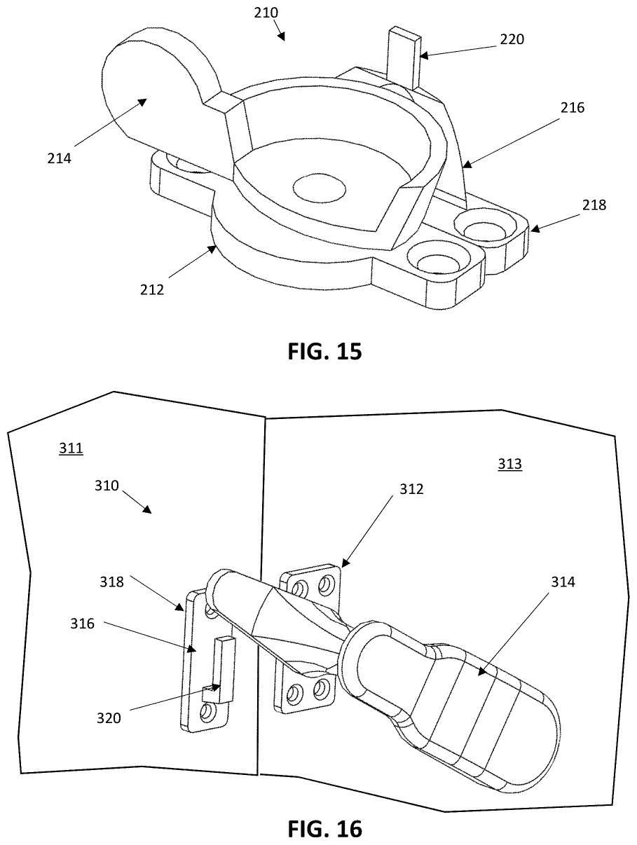

FIGS. 13-15 illustrate a fifth exemplary embodiment of the exemplary disclosed mechanism. The exemplary disclosed mechanism may include a mechanism such as a latch mechanism 210 (e.g., rotating latch mechanism such as a window latch). Latch mechanism 210 may include a window plate 212 that may be attached to an assembly such as a window 211 (e.g., or any other suitable assembly that may selectively allow access to a structure such as a building). Window 211 is not shown in FIGS. 14 and 15 for sake of clarity. A latch handle 214 may be attached to window plate 212, and may be configured to rotate freely. A catch component 216 may be attached to a wall (e.g., that may be similar to wall 13, but not shown for sake of clarity) adjacent to window 211. Catch component 216 may include (e.g., may be formed partially or substantially entirely from) SMA material as described for example herein. Catch component 216 may include a base 218, which may mate to the exemplary wall, and a retaining portion 220 (e.g., that may include SMA material) that may be curved back towards the exemplary wall when in its first state (e.g., martensite state). Retaining portion 220 when in its first state (e.g., martensite state) may then receive latch handle 214 as illustrated in FIG. 14. Also as illustrated in FIG. 14, latch mechanism 210 may then be locked by latch handle 214 being held by retaining portion 220 (e.g., curved retaining portion) of catch component 216 while catch component 216 is in its first state (e.g., martensite state). Portions of catch component 216 including SMA material may be in its first state (e.g., martensite state) at typical ambient room temperatures. For example, at any temperature of the SMA material below the exemplary transition temperature as described herein (e.g., a temperature of the SMA material corresponding to an ambient temperature of 120 degrees Fahrenheit), portions of catch component 216 including SMA material may be in its martensite state.

When ambient temperature rises (e.g., due to a fire), SMA material of catch component 216 may change phase back to its second state (e.g., austenite state). For example, as the ambient temperature rises above 120 degrees Fahrenheit or any other suitable as described for example herein, the SMA material may change to its second state (e.g., austenite state). For example, the exemplary ambient temperature corresponding to the exemplary transition temperature of the SMA material may be a temperature not typically reached unless there is a fire (e.g., but a temperature that may be lower than what would cause harm to a human or animal).

FIG. 15 illustrates catch component 216 having portions including SMA material in its second state (e.g., austenite state). When the ambient temperature rises and causes the temperature of the SMA material to exceed the exemplary transition temperature as described for example above, previously curved retaining portion 220 may bend back to its second state (e.g., austenite state). Retaining portion 220 may move (e.g., may straighten out, becoming perpendicular to the exemplary wall). Though latch handle 214 may still be in its locked position, latch mechanism 210 may actually be unlocked. For example, a small child located inside the house would then be able to push the window open, thereby allowing the child to safely exit unsafe conditions (e.g., a burning structure).

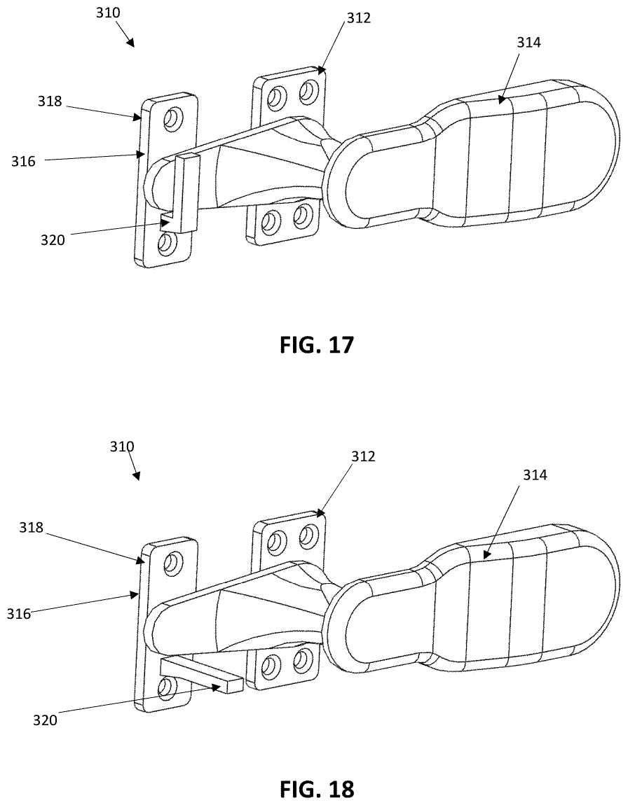

FIGS. 16-18 illustrate a sixth exemplary embodiment of the exemplary disclosed mechanism. The exemplary disclosed mechanism may include a latch mechanism 310 (e.g., a rotating latch mechanism such as a window latch). Latch mechanism 310 may include a window plate 312 that may be attached to an assembly such as a window 313 or other suitable assembly. A latch handle 314 may be attached to window plate 312 and may be configured (e.g., allowed) to rotate freely. A catch component 316 may be attached to an assembly such as a wall 311 that may be adjacent to window 313 and in which window 313 may be disposed. Wall 311 and window 313 are not shown in FIGS. 17 and 18 for sake of clarity. Some or substantially all portions of catch component 316 may be formed from exemplary SMA material as described for example herein. Catch component 316 may include a base 318, which may or may not include SMA material, mating to wall 311. Catch component 316 may also include a retaining portion 320 that may be curved back to be parallel to wall 311 when in its first state (e.g., martensite state). Retaining portion 320 when in its first state (e.g., martensite state) may receive latch handle 314 as illustrated in FIG. 17. As illustrated in FIG. 17, latch mechanism 310 may then be locked, with latch handle 314 being held by retaining portion 320 (e.g., a bent retaining portion) of catch component 316 in its first state (e.g., martensite state). Similar to as described above, SMA material of retaining portion 320 may be in its first state (e.g., martensite state) at typical ambient room temperatures (e.g., at temperatures below 120 degrees Fahrenheit or other suitable ambient temperatures corresponding to the exemplary transition temperature as described for example herein).

As described for example above, once an ambient temperature rises (e.g., due to a fire), SMA material of catch component 316 may change phase back to its second state (e.g., austenite state). For example, as the ambient temperature rises above an ambient temperature (e.g., 120 degrees Fahrenheit or any other suitable temperature as described herein) corresponding to the exemplary transition temperature, retaining portion 320 may change to its second state. FIG. 18 illustrates SMA material of catch component 316 in its second state (e.g., austenite state). For example in its second state (e.g., austenite state), previously curved retaining portion 320 may move (e.g., bend) back to its second state (e.g., austenite state) for example in which it straightens out (e.g., becoming perpendicular to the exemplary wall). At this point, though latch handle 314 may still be in its locked position, the latch mechanism 310 may actually be unlocked. A small child or other occupant located inside the house would then be able to push window 313, allowing them to safely exit the unsafe conditions (e.g., burning structure).

In addition to changing between martensite and austenite states based on temperature, the exemplary material that may behave similarly to SMA material may change between any desired states based on any desired criteria such as presence or absence of electrical current, presence or absence of light or other radiation, and/or any other desired conditions or criteria.

The exemplary disclosed apparatus and method may be used in any suitable application for providing automatic opening or release of a mechanism such as a latch or other locking device. For example, the exemplary disclosed apparatus and method may be used in any application involving providing automatic opening or release during an emergency such as a fire. The exemplary disclosed apparatus and method may be used in any application in which a door or other member is to be opened automatically when a capable operator for opening that door or other member is not present. The exemplary disclosed apparatus and method may be used in any application for providing automatic opening or release based on predetermined conditions such as a threshold ambient temperature being reached. In at least some exemplary embodiments, the exemplary disclosed apparatus and method may be used in windows or doors of children's rooms. Additionally for example, the exemplary disclosed apparatus and method may be used in animal kennels or stalls. Also for example, the exemplary disclosed apparatus and method may be used on any suitable door or window such as a member of a building, vehicle such as a car or truck, an air vehicle such as an aircraft (e.g., fixed wing or rotary wing aircraft), a waterborne craft such as a boat or ship, and/or any other suitable member.

In at least some exemplary embodiments, the exemplary disclosed mechanism may include a mechanical latch mechanism such as a shape memory fire safety latch release. The exemplary mechanical latch mechanism may include at least one portion made from shape memory alloy (SMA) that may be repeatedly latched and unlatched while it is in a first state (e.g., martensitic state). The first state (e.g., martensite state) may occur at normal ambient temperatures. In the case of elevated temperatures (e.g., in the case of a fire), the ambient temperature may rise, and cause the SMA material to revert to its second state (e.g., austenite state). For example, the SMA material may revert from the second state to the first state when a transition temperature is exceeded. In its second state (e.g., austenite state), the exemplary latch component including SMA would cause the latch to release (e.g., unlatch), thereby allowing a door, a window, or other assembly to open. The latch release including SMA material would reach its second state (e.g., austenite state) at an ambient temperature that may be above normal ambient temperatures, but well below a harmful temperature threshold that could cause damage or harm to a human or an animal.

In at least some exemplary embodiments, the exemplary disclosed mechanism may include a first member (e.g., catch component 16, catch component 216, or catch component 316), and a second member (e.g., latch handle 14, latch handle 214, and latch handle 314) that is rotatable relative to the first member, the second member being rotatable in a first direction between a first position and a second position. The second member may contact the first member and may be received by the first member when the second member is in the second position. The first member may include a shape memory alloy portion. The shape memory alloy portion may be movable between a first shape when in a first state and a second shape when in a second state. The shape memory alloy portion may move from the first shape to the second shape based on a temperature of the shape memory alloy portion exceeding a threshold transition temperature of the shape memory alloy portion. The shape memory alloy portion may move in a second direction, which may be different from the first direction, when moving from the first shape to the second shape. The first state may be a martensite state and the second state may be an austenite state. The shape memory alloy portion may include material selected from the group consisting of TiNi, CuAlNi, and TiNiPd. The threshold transition temperature of the shape memory alloy portion may be the temperature of the shape memory alloy portion corresponding to an ambient temperature of 120 degrees Fahrenheit. After moving from the first shape to the second shape, the shape memory alloy portion may remain in the second shape when the temperature of the shape memory alloy portion decreases below the threshold transition temperature. The latch mechanism may be a door latch or a window latch. The first member and the second member may be components of a rotatable window latch. The first direction may be perpendicular to the second direction. The shape memory alloy portion may block the second member from moving in the second direction when the second member is received by the first member and the shape memory alloy portion is in the first shape, and the shape memory alloy portion may allow the second member to move in the second direction when the second member is received by the first member and when the shape memory alloy portion is in the second shape.

In at least some exemplary embodiments, the exemplary disclosed method may include providing a first member attached to a first assembly (e.g., wall 13, enclosure 132, or wall 311) providing a second member attached to a second assembly (e.g., door 11, front wall 112, and window 313), moving the second assembly relative to the first assembly between an open position and a closed position, and receiving one of the first and second members with the other of the first and second members when the second assembly is in the closed position to lock the second assembly to the first assembly. At least one of the first member and the second member may include a shape memory alloy portion. The shape memory alloy portion may be movable between a first shape at a first ambient temperature and a second shape at a second ambient temperature that is greater than the first ambient temperature. The exemplary disclosed method may also include unlocking the second assembly from the first assembly by moving the shape memory alloy portion from the first shape to the second shape. The first ambient temperature may be less than 120 degrees Fahrenheit. The first ambient temperature may be between 32 degrees Fahrenheit and 120 degrees Fahrenheit. The first assembly may be a wall and the second assembly may be selected from the group consisting of a door and a window. The shape memory alloy portion may move from the first shape to the second shape when an ambient temperature increases from the first ambient temperature to the second ambient temperature. After moving from the first shape at the first ambient temperature to the second shape at the second ambient temperature, the shape memory alloy portion may remain in the second shape when the ambient temperature decreases from the second ambient temperature to the first ambient temperature. The exemplary disclosed method may also include mechanically bending the shape memory alloy portion from the second shape to the first shape at the first ambient temperature.

In at least some exemplary embodiments, the exemplary disclosed apparatus may include a first assembly (e.g., enclosure 132), a second assembly (e.g., front wall 112) disposed adjacent to the first assembly and selectively movable relative to the first assembly between an open position and a closed position, a first member attached to the first assembly, and a second member attached to the second assembly, the second member being movable in a first direction between a first position and a second position. The second member may be received by the first member when the second member is in the second position to lock the second assembly to the first assembly in the closed position. The first member may include a shape memory alloy portion. The shape memory alloy portion may be movable between a first shape at a first temperature of the shape memory alloy portion and a second shape at a second temperature of the shape memory alloy portion. The second temperature may be greater than the first temperature. The shape memory alloy portion may move in a second direction, which may be different from the first direction, when moving from the first shape to the second shape. The shape memory alloy portion moving from the first shape to the second shape may unlock the second assembly from the first assembly. The second assembly may be a door and the first assembly may be a wire mesh animal crate. The shape memory alloy portion may be selected from the group consisting of a u-shaped handle of the second member and a receiving loop of the first member. The first state may be a martensite state and the second state may be an austenite state.

The exemplary disclosed apparatus and method may provide an efficient and effective technique for opening a door, window, or other member automatically based on predetermined criteria. For example, the exemplary disclosed apparatus and method may provide a technique for automatically opening a door, window, or other member automatically during a fire to allow children and animals to escape a building or other structure that has caught fire. The exemplary disclosed apparatus and method may thereby provide a safety device for allowing occupants or animals housed in a building or other structure to escape that building or other structure in case of an emergency such as fire.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A latch mechanism, comprising:
a first member; and
a second member that is rotatable relative to the first member, the second member being rotatable in a first direction between a first position and a second position;
wherein the second member contacts the first member and is received by the first member when the second member is in the second position;
wherein the first member includes a shape memory alloy portion;
wherein the shape memory alloy portion is movable between a first shape when in a first state and a second shape when in a second state;
wherein the shape memory alloy portion moves from the first shape to the second shape based on a temperature of the shape memory alloy portion exceeding a threshold transition temperature of the shape memory alloy portion; and
wherein the shape memory alloy portion moves in a second direction, which is different from the first direction, when moving from the first shape to the second shape.

2. The latch mechanism of claim 1, wherein the first state is a martensite state and the second state is an austenite state.

3. The latch mechanism of claim 1, wherein the shape memory alloy portion includes material selected from the group consisting of TiNi, CuAlNi, and TiNiPd.

4. The latch mechanism of claim 1, wherein the threshold transition temperature of the shape memory alloy portion is the temperature of the shape memory alloy portion corresponding to an ambient temperature of 120 degrees Fahrenheit.

5. The latch mechanism of claim 1, wherein after moving from the first shape to the second shape, the shape memory alloy portion remains in the second shape when the temperature of the shape memory alloy portion decreases below the threshold transition temperature.

6. The latch mechanism of claim 1, wherein the latch mechanism is a door latch or a window latch.

7. The latch mechanism of claim 1, wherein the first member and the second member are components of a rotatable window latch.

8. The latch mechanism of claim 1, wherein the first direction is perpendicular to the second direction.

9. The latch mechanism of claim 1, wherein the shape memory alloy portion blocks the second member from moving in the second direction when the second member is received by the first member and the shape memory alloy portion is in the first shape, and the shape memory alloy portion allows the second member to move in the second direction when the second member is received by the first member and the shape memory alloy portion is in the second shape.

10. A method, comprising:
providing a first member attached to a first assembly;
providing a second member attached to a second assembly;
moving the second assembly relative to the first assembly between an open position and a closed position;
receiving one of the first and second members with the other of the first and second members when the second assembly is in the closed position to lock the second assembly to the first assembly;
wherein at least one of the first member and the second member includes a shape memory alloy portion;
wherein the shape memory alloy portion is movable between a first shape at a first ambient temperature and a second shape at a second ambient temperature that is greater than the first ambient temperature; and
unlocking the second assembly from the first assembly by moving the shape memory alloy portion from the first shape to the second shape.

11. The method of claim 10, wherein the first ambient temperature is less than 120 degrees Fahrenheit.

12. The method of claim 10, wherein the first ambient temperature is between 32 degrees Fahrenheit and 120 degrees Fahrenheit.

13. The method of claim 10, wherein the first assembly is a wall and the second assembly is selected from the group consisting of a door and a window.

14. The method of claim 10, wherein the shape memory alloy portion moves from the first shape to the second shape when an ambient temperature increases from the first ambient temperature to the second ambient temperature.

15. The method of claim 14, wherein after moving from the first shape at the first ambient temperature to the second shape at the second ambient temperature, the shape memory alloy portion remains in the second shape when the ambient temperature decreases from the second ambient temperature to the first ambient temperature.

16. The method of claim 15, further comprising mechanically bending the shape memory alloy portion from the second shape to the first shape at the first ambient temperature.

17. An apparatus, comprising:
a first assembly;
a second assembly disposed adjacent to the first assembly and selectively movable relative to the first assembly between an open position and a closed position;
a first member attached to the first assembly; and
a second member attached to the second assembly, the second member being movable in a first direction between a first position and a second position;
wherein the second member is received by the first member when the second member is in the second position to lock the second assembly to the first assembly in the closed position;
wherein the first member includes a shape memory alloy portion;
wherein the shape memory alloy portion is movable between a first shape at a first temperature of the shape memory alloy portion and a second shape at a second temperature of the shape memory alloy portion;
wherein the second temperature is greater than the first temperature;
wherein the shape memory alloy portion moves in a second direction, which is different from the first direction, when moving from the first shape to the second shape; and
wherein the shape memory alloy portion moving from the first shape to the second shape unlocks the second assembly from the first assembly.

18. The apparatus of claim 17, wherein the second assembly is a door and the first assembly is a wire mesh animal crate.

19. The apparatus of claim 17, wherein the shape memory alloy portion is selected from the group consisting of a u-shaped handle of the second member and a receiving loop of the first member.

20. The apparatus of claim 17, wherein the first state is a martensite state and the second state is an austenite state.
